(19) United States
(12) Patent Application Publication
(10) Pub. No.: US 2022/0007702 A1
(43) Pub. Date: Jan. 13, 2022

(54) METHODS AND SYSTEMS FOR PRODUCTION OF REDUCED FAT CONTINUOUS CONFECTIONS CONTAINING INSOLUBLE DIETARY FIBERS

(71) Applicant: Intercontinental Great Brands LLC, East Hanover, NJ (US)

(72) Inventors: Indraneil Mukherjee, East Hanover, NJ (US); Kieran P. Spelman, East Hanover, NJ (US)

(21) Appl. No.: 16/927,865

(22) Filed: Jul. 13, 2020

(51) Int. Cl. A23L 33/22; A23L 33/24; A23L 33/115; A23L 33/125; A23G 1/40; A23G 1/36; A23G 3/42; A23G 3/40; A23G 3/54; A23G 1/54

(52) U.S. Cl. CPC A23L 33/22; A23L 33/24; A23L 33/115; A23L 33/125; A23G 1/40; A23V 2002/00; A23G 3/42; A23G 3/40; A23G 3/54; A23G 1/54; A23G 1/36

(57) ABSTRACT

Fat continuous confections, such a crèmes and crème-type fillings, and methods of making thereof are provided. The fat continuous confections have a high insoluble dietary fiber content and do not include sugar alcohols. The fat continuous confections have a crème-like smooth and continuous texture and have a reduced fat content/calorie content, providing consumers with a desirable taste and organoleptic properties and also satisfying today's health-conscious consumers.

### FIELD

The present application generally relates to continuous confections, and more particularly to fat continuous confections containing high levels of insoluble dietary fibers.

### BACKGROUND

Fat continuous confections (FCCs), for example, crèmes, fat-based fillings, chocolate, and the like, are appreciated by consumers, as they provide confectionery products with a rich, indulgent, sensorially-pleasant mouthfeel. Generally, a fat continuous confection is a single cohesive mass where solid particles of sweetener (e.g., sugar), bulking agent (e.g., starch, cocoa, fibers, nut powders), etc., are held together within a fat matrix. Certain fat continuous confections may further contain flavor-providing and/or aesthetically-pleasing inclusions such as nuts, dry fruit pieces, sprinkles, or the like. At room temperature, the fat matrix may be in the solid state (e.g., chocolate, etc.), or semi-solid state (e.g., crème, nut butters, etc.), which determines the sensory texture (i.e., firm or soft) of the confection. Fat continuous confections are also known to “flow” when they are in a predominantly liquid state, which typically occurs when the fat continuous confection is heated to a temperature that is at or above the melting temperature of the fat.

Conventional fat continuous confections are typically high in fats and sugars, and are thus also high in calorie content. This may be undesirable for certain consumers, especially given the modern trend toward low calorie/low sugar products, and the ever-growing concern with obesity and obesity-related conditions, which are often tied to excessive consumption of foods that are high in calories and sugars. Typically, fats are the highest caloric contributors in foods, contributing 9 kcal/g when fully caloric. While low calorie fats do exist (e.g., Salatrim™, Olestra™, etc.), such low calorie fats may be associated by some consumers with undesirable digestive effects. By comparison, fully caloric carbohydrates contribute 4 kcal/g, and low calorie carbohydrates (e.g., dietary fibers) may contribute, depending on applicable regulations, from about 0 to about 2.5 kcal/g. Table 1 shows a variety of examples of commercially available reduced sugar and reduced calorie fat continuous confections (note: on commercial food product labels, total dietary fiber (TDF) is typically simply referred to as dietary fiber (DF).)

TABLE 1
Exemplary Commercially Available Reduced Sugar/Fat/Calorie Confections

| Product | Ingredients & Nutrition facts | Ingredient Notes |
|---|---|---|
| Sugar Free Oreo | Maltitol, unbleached enriched flour | Soluble fibers polydextrose and |
| | (wheat flour, niacin, reduced iron, | inulin provide 3 g of the total dietary |
| | thiamine mononitrate (vitamin B1), | fiber, but these are ingredients of the |
| | riboflavin (vitamin B2), folic acid), | biscuit base cake, (not components of |
| | high oleic canola and/or palm oil, | a fat continuous confection). |
| | polydextrose, cocoa (processed with | Total dietary fiber weight percentage |
| | alkali), cornstarch, glycerin, inulin | is 3 g/24 g = 12.5%. |
| | (natural extract from chicory root), | In the fat continuous confection (i.e., |
| | emulsifiers (vegetable mono- and | crème), maltitol and glycerin (i.e., |
| | diglycerides, soy lecithin), leavening | sugar alcohols are the major bulking |
| | (baking soda and/or sodium acid | agents, and no insoluble dietary fibers |
| | pyrophosphate and/or calcium | are present. |
| | phosphate), salt, dextrose*, natural and | |
| | artificial flavor, cellulose gum and gel, | |
| | chocolate, heavy cream (from milk), | |
| | acesulfame potassium (sweetener), | |
| | sucralose (sweetener). | |
| | Serving: 24 g; calories: 90; total fat: 5 g; | |
| | total carb: 17 g (sugars: 0 g; dietary | |
| | fiber: 3 g; sugar alcohol: 8 g). | |
| Nuti Light Sugar | Chicory dietary fiber, palm oil, | Erythritol is a sugar alcohol. |
| Free Spread | erythritol, almond, cocoa powder, | Chicory is a soluble fiber. |
| | sunflower lecithin, pure vanilla extract, | No Insoluble fibers used. |
| | stevia leaf extract. | Carb to Fat ratio is 17 g:12 g = 1.4:1. |
| | Serving: 32 g; calories: 130; total fat: | Total dietary fiber weight percentage |
| | 12 g; total carb: 17 g (sugars: 0 g; dietary | is 12 g/32 g = 38%. |
| | fiber: 12 g; sugar alcohol: 4 g). | |
| Lakanto ® Sugar | Arriba cocoa beans, Lakanto Sweetener | Erythritol is a sugar alcohol |
| Free Chocolate | (erythritol, monk fruit extract), cocoa | Vegetable fiber (type unknown, so |
| Bars | butter, vegetable fiber, sunflower | not clear if this is soluble of |
| | lecithin, sea salt, natural flavors. | insoluble). |
| | Serving: 43 g; calories: 120; total fat: | Carb to Fat ratio is 27 g:11 g = 2.5:1. |
| | 11 g; total carb: 27 g (sugars: 0 g; dietary | Total dietary fiber percentage is |
| | fiber: 9 g; sugar alcohol: 12 g). | 9 g/43 g = 21%. |
| Choczero ® 50% | Dark chocolate (unsweetened | Soluble corn fiber is used as bulking |
| Cocoa Dark | chocolate, cocoa butter), soluble corn | agent. |
| Chocolate | fiber (GMO free), sunflower lecithin, | No insoluble fibers are used. |
| | monk Fruit Extract, Madagascar | Carb to Fat ratio is 6 g:4.5 g = 1.3:1. |
| | bourbon vanilla beans. | Total dietary fiber percentage is |
| | Serving: ~10 g; calories: 40; total fat: | 5 g/10 g = 50%. |
| | 4.5 g; total carb: 6 g (sugars: 0 g; dietary | |
| | fiber: 5 g; sugar alcohol: 0 g). | |
| Choco | Dry cocoa solids, chicory root fiber, | Erythritol is a sugar alcohol. |
| Perfection Dark | erythritol, cocoa butter, calcium | Chicory is a soluble fiber. |
| European | carbonate, butter, oil, soy lecithin, | No Insoluble fibers are used. |
| Chocolate Bar | vanilla extract. | Carb to Fat ratio is 24 g:18 g = 1.3:1. |
| | Serving: 50 g; calories: 197; total fat: | Total dietary fiber percentage is |
| | 18 g; total carb: 24 g (sugars: 0 g; dietary | 14 g/50 g = 28% |
| | fiber: 14 g; sugar alcohol: 8 g) | |
| Simply Lite ® | Maltitol, cocoa butter, whole milk | Maltitol is a sugar alcohol. |
| Milk Chocolate | powder, chocolate liquor, inulin | Inulin is a soluble fiber. |
| | (natural vegetable fiber), soy lecithin, | No Insoluble fibers used. |
| | vanilla. | Carb to Fat ratio is 14 g:9 g = |
| | Serving: 25 g; calories: 120; total fat: | 1.56:1. |
| | 9 g; total carb: 14 g (sugars: 2 g; dietary | Total dietary fiber percentage is |
| | fiber: 3 g; sugar alcohol: 9 g). | 3/25 = 12%. |
| Innocent | Cacao, organic erythritol, organic | Maltitol is a sugar alcohol. |
| Chocolate ® | stevia, beta cyclodextrin, glycerol | Beta cyclodextrin is a soluble fiber. |
| Sold as a | monoolete. | No insoluble fibers are used. |
| Supplement | Serving: 37.5 g; calories: 181; total fat: | Carb to Fat ratio is 18 g:15 g = 1.2:1. |
| | 15 g; total carb: 11 g (sugars: 0 g; dietary | Total dietary fiber percentage is |
| | fiber: 14 g; erythritol: 4 g; net carbs - | 14 g/37.5 g = 37.3%. |
| | fiber). | |
| | Note - manufacturer calculations are | |
| | not standard. Based on data provided, | |
| | Total Carb = 14 + 4 = 18 g. | |
| ChocoRite ® | Chocolate liquor, erythritol, soluble | Erythritol is a sugar alcohol. |
| Dark Chocolate | corn fiber, milk protein concentrate, | The fibers used are soluble corn fiber, |
| Bars | isomalto-oligosaccharides, inulin, soy | isomalto-oligosaccharides (soluble |
| | lecithin, natural vanilla flavor, salt, | fiber), and inulin (soluble fiber). |
| | stevia extract. | No insoluble fibers are used. |
| | Serving: 28 g; calories: 110; total fat: | Carb to Fat ratio is 13 g:10 g = 1.3:1. |
| | 10 g; total carb: 13 g (sugars: 0 g; dietary | Total dietary fiber percentage is |
| | fiber: 7 g; erythritol: 6 g). | 7 g/28 g = 25%. |
| SkinnyMe Bold | Unsweetened chocolate, inulin, | Erythritol is a sugar alcohol. |
| Dark Chocolate | resistant dextrin, erythritol, cocoa | The fibers used are resistant dextrin |
| Bars | butter, milkfat, organic soy lecithin, | (soluble fiber) and inulin (soluble |
| | natural flavors, stevia extract, vanilla | fiber) |
| | extract. | No Insoluble fibers used. |
| | Serving: 11 g; calories: 45; total fat: 4 g; | Carb to Fat ratio is 6 g:4 g = 1.5:1. |
| | total carb: 6 g (sugars: 0 g; dietary fiber: | Total dietary fiber percentage is |
| | 3 g; erythritol: 2 g) | 3 g/11 g = 27%. |
| Cadbury Dairy | Sugar, milk solids, soluble corn fiber, | Soluble corn fiber is used |
| Milk 30% less | cocoa butter, cocoa solids, edible | No insoluble fibers are used. |
| sugar | vegetable fat, emulsifiers. | Carb to Fat ratio is 58.2 g:29.7 g = 2:1. |
| | Serving: Per 100 g; calories: 503; total | Total dietary fiber percentage is |
| | fat: 29.7 g; total carb: 58.2 g (sugars: | 15.8 g/100 g = 15.8%. |
| | 37.9 g; dietary fiber: 15.8 g; sugar | |
| | alcohol: 0 g). | |

As can be seen in Table 1 above, while a number of low sugar and low calorie fat continuous confections are commercially available, the vast majority of such products include sugar alcohols (polyols). Notably, due to the consumer sensitivity they are associated with, sugar alcohols have to be explicitly listed on a separate row in the product's Nutrition Facts, and require laxation warnings at high use levels.

Table 1 also shows that most of the commercially available low sugar and low calorie fat continuous confections only provide a limited amount of total dietary fiber, and most do not include any insoluble dietary fiber (IDF). Notably, the term dietary fiber generally refers to the indigestible portion of food derived from plants and has two components, namely, soluble dietary fiber and insoluble dietary fiber. Soluble dietary fiber dissolves in water and may be readily fermented in the colon into gases and physiologically active byproducts. On the other hand, insoluble dietary fiber does not dissolve in water and is known to provide a bulking effect by absorbing water as the insoluble dietary fiber moves through the digestive system

Insoluble dietary fibers are particularly beneficial relative to other types of carbohydrates because they provide even fewer calories relative to soluble fibers (the insoluble dietary fiber portion of the total dietary fiber is 0 kcal/g, while the soluble dietary fiber counts as 2 kcal/g). In addition, insoluble dietary fibers are known to be better tolerated digestively, likely due to lower rate of gas generation from microbial fermentation in the colon. Further, since insoluble dietary fibers are not sugar alcohols, they do not require an additional row in Nutritional Facts disclosure, or laxation warnings at high use levels.

As can be understood by looking at the formulations seen in Table 1 above, incorporation of high levels of insoluble fibers into low calorie/low fat/low sugar fat continuous confections is a significant challenge for a confectionery formulator. In particular, unlike crystalline sucrose (e.g., icing sugar), soluble fibers, and sugar alcohols, insoluble fibers, when used as sugar replacers/bulking agents, tend to absorb a portion of the available fat from the fat continuous confection. This decreases the amount of fat available to efficiently suspend the insoluble fiber particles and maintain a continuous crème or chocolate. Thus, the ability of a bulking agent to effectively replace sugar in fat continuous confection depends on its ability to be suspended in the fat-continuous matrix without absorbing too much of the available liquid fat (which would result in a dry dough-like, discontinuous (heterogeneous), granular or powder-like mass, not a desired smooth, continuous (homogeneous) crème- or chocolate-like mass).

US20150086686 teaches confectionery compositions that include from 10 wt. % to 40 wt. % insoluble dietary fibers. However, these compositions require the presence of at least 25 wt. % sweetener (while noting that sugar alcohols may replace a portion of the sugars), which may not be desirable by consumers. In addition, these compositions include from 0.01 wt. % to 20 wt. % blending agent, which, when used in combination with at least 25 wt. % sweetener, results in discontinuous powders instead of fat continuous confections, as will be discussed herein below.

### SUMMARY

In view of the foregoing, the present inventors recognized that there is clearly a market need for fat continuous confections that are low sugar and low in calories, but are sugar alcohol-free. In addition, the present inventors determined that there is a need for low calorie fat continuous confections with low fat content relative to carbohydrate and fiber content, since higher fat levels would increase the calorie content of the fat continuous confections. In addition, the present inventors recognized that it is desirable to increase the carbohydrate content, preferably the fiber content, at the expense of fat in low calorie fat continuous confections. Given the advantages of insoluble dietary fibers over other types of carbohydrates, the present inventors determined that it is most beneficial to increase the insoluble dietary fiber content in low calorie fat continuous confections at the expense of fat.

Generally, low calorie and low fat continuous confections having high levels of insoluble dietary fiber are described herein. In some embodiments, a fat continuous confection comprises at least 24 wt. % insoluble dietary fiber, from about 14 wt. % fat to about 39 wt. % fat; and from about 0 wt. % to about 20 wt. % sweetener. In other embodiments, the fat continuous confection comprises from about 24 wt. % to about 56 wt. % insoluble dietary fiber; from about 22 wt. % fat to about 39 wt. % fat; and from about 22 wt. % to about 35 wt. % sweetener. The insoluble dietary fiber may be from a source including, but not limited to: brans, celluloses, hemicelluloses, lignins, resistant starches, flours, insoluble chicory root fiber, isolated plant fibers, cocoa powder, pecan shell fiber, cocoa pod husk fiber, and agave pina fiber, or the like.

Without wishing to be limited by theory, the present inventors have found and demonstrated that sugar (e.g., sucrose) can be replaced up to 100% in fat continuous confections (e.g., fat-based crème formulations) using several different food ingredients as sugar replacers, such that these sugar replacer ingredients serve to occupy the volume occupied by sugar crystals in the original full-sugar fat continuous confection. By doing so, these sugar replacer food ingredients effectively act as “bulking agents” in fat continuous confections, providing a level of insoluble dairy fiber from about 24 wt. % to about 56 wt. % of the fat continuous confection in some embodiments and from about 24 wt. % to about 86 wt. % of the fat continuous confection in other embodiments. The present inventors also discovered that in addition to being able to replace all of the sugar in a fat continuous confection, the bulking agents can be advantageously used to replace a portion of the fat as well, resulting in some fat continuous confections that have very low fat (e.g., as low as 14 wt. %).

As shown in the Examples section below, the present inventors were able to successfully prepare calorie-reduced, sugar-reduced, and sugar-free crèmes as exemplary inventive fat continuous confections. Such crèmes may be used as low sugar and low calorie fillings for a variety of confectionery products, for example, sandwich cookies (e.g., Oreo, NutterButter, etc.), fillings (e.g., candy, eclairs, doughnuts, etc.), icings (for cakes, doughnuts, etc.), and the like. In addition, the fat continuous confections described herein may be advantageously used in a wide variety of types of low-sugar and low-calorie chocolate products (e.g., chocolate bars, chocolate chips, chocolate filling), spreads, nut-butters, and the like.

### BRIEF DESCRIPTION OF THE DRAWINGS

FIG. 1 is a photograph depicting a side-by-side comparison of an exemplary inventive fat continuous confection (a crème) on the right and an exemplary comparative discontinuous confection (powder) on the left;

FIG. 2 shows a thermomechanical analyzer (TMA) graph, representing the rheological properties of the crème and powder depicted in FIG. 1;

FIG. 3A is a photograph depicting a side-by-side comparison of two inventive crème-like fat continuous confections and two comparative powder-like non-continuous confections;

FIG. 3B shows a TMA graph, representing the rheological properties of the confections depicted in FIG. 3A;

FIG. 4A is a photograph depicting a side-by-side comparison of two crème-like fat continuous confections and four powder-like comparative non-continuous confections;

FIG. 4B shows a TMA graph, representing the rheological properties of the confections depicted in FIG. 4A; and

FIG. 5 shows a TMA graph, representing the rheological properties of an exemplary comparative powder and two inventive fat continuous chocolate confections.

### DETAILED DESCRIPTION

The present application is generally directed to fat continuous confections that advantageously have reduced fat and calorie content while having high insoluble dietary fiber content and exhibiting pleasant organoleptic properties when consumed. Generally, exemplary advantageous fat continuous confections according to some of the embodiments described herein include from about 24 wt. % to about 86 wt. % insoluble dietary fiber, from about 14 wt. % fat to about 39 wt. % fat, and from about 0 wt. % to about 20 wt. % sweetener. Exemplary advantageous fat continuous confections according to some other embodiments described herein include from about 24 wt. % to about 56 wt. % insoluble dietary fiber; from about 22 wt. % fat to about 39 wt. % fat; and from about 22 wt. % to about 35 wt. % sweetener.

As used herein, the term “fat continuous confection” refers to a single cohesive mass where the solid particles (e.g., particles of sweetener, bulking agent, etc.), are held together within a fat matrix. In other words, the term fat continuous confection refers to a cohesive confectionery mass that is smooth and crème-like, and excludes granular and powder-like confectionery compositions. In various embodiments, the fat continuous confection includes, but is not limited to: a chocolate, a crème, a crème filling of a baked product, a savory (e.g., cheese or the like) filling, a chocolate chip of a chocolate chip cookie, an icing of a doughnut, an icing of a cake, a chocolate filling enrobed by a chocolate layer, an icing of a doughnut, a nut butter, and the like.

Generally speaking, fat continuous confections are low moisture systems and have a water activity (A_{w}) of 0.7 or below (e.g., from 0.1-0.7), since the presence of aqueous phase (e.g., water droplets) in a fat continuous dispersion (e.g., chocolate) can disrupt the stability of the fat continuous confection. Also, it is generally understood that fat continuous confections are not emulsions, but rather are dispersions of carbohydrate particles suspended in a continuous fat matrix (e.g., chocolate, crème, etc.), with the carbohydrate phase (e.g., dietary fiber, sweetener, etc.) being made up of solid particles, their moisture content notwithstanding.

As mentioned above, replacing fat and sugar in fat continuous confections with bulking agents rich in insoluble dietary fiber is particularly advantageous and leads to significant calorie and sugar reduction. Examples of commercially available insoluble dietary fiber-rich bulking agents that may be used in fat continuous confections according to some embodiments described herein include, but are not limited to: brans (e.g., oat, corn, barley, wheat, rice, etc.), cellulose of various food grades (e.g., microcrystalline cellulose, supercritical crystalline cellulose, amorphous cellulose, etc.), insoluble chicory root fiber, isolated plant fibers (pea fiber, wheat fiber, oat fiber, vanilla fiber, sugarcane fiber, insoluble chicory root fiber, citrus fiber, etc.), resistant starches (e.g., high amylose—RS2, chemically modified—RS4), cocoa powder (e.g., defatted cocoa powder), ground up plant waste, such as stones, pits, and husks (e.g., pecan shell fiber, cocoa shell fiber, cocoa pod husk fiber, agave pina fiber, pistachio shell powder, etc.), and the like.

As mentioned above, the fat continuous confections according to various embodiments described herein include at least 24 wt. % insoluble dietary fiber, and, more particularly, from about 24 wt. % to about 56 wt. % insoluble dietary fiber in some embodiments, and from about 24 wt. % to about 86 wt. % insoluble dietary fiber in other embodiments, which represents a significant and advantageous increase in the insoluble dietary fiber content of the inventive fat continuous confections described herein relative to the conventional fat continuous confections. In particular, since the increase in insoluble fiber content of the fat continuous confections is at the expense of fat and sugar content, the increase in insoluble fiber levels achieved by the present inventors results in fat continuous confections with low fat, sugar, and calorie content, which are desirable for consumers.

Surface properties such as oil binding capacity and specific surface area (SSA) are known to influence the ability of a bulking agent to form a smooth, homogeneous fat continuous confection such as a crème. Beyond the ability of a bulking agent to form a fat continuous confection, the size of the bulking agent particles needs to be sufficiently small in so as not to offer undesirable sensory characteristics such as grittiness in the mouth, which is not desirable. In some embodiments, the average particle size of the bulking agent ranges from about 2 microns to about 120 microns.

As mentioned above, the fat continuous confections according to various embodiments described herein include at least 14 wt. % and, more particularly, from about 14 wt. % to about 39 wt. % fat. Notably, the Examples section of the present application shows that each of the inventive fat continuous confections has a fat content of 14 wt. % or above, and that none of the confections having a fat content below about 14 wt. % form a fat continuous confection, instead forming a discontinuous powder. Exemplary fat components that may be used in the fat continuous confections described herein include but are not limited to: canola oil, palm oil, high oleic canola oil, soybean, safflower, sunflower, palm kernel oil, coconut oil, milk fat, shea butter, mango kernel oil, illipe oil, sal oil, olive oil, cocoa butter or fractions or equivalents of cocoa butter, polyglycerol esters, glycerophospholipids, mono- and di-glycerides.

As mentioned above, the fat continuous confections according to various embodiments described herein include from about 0 wt. % (e.g., 0.01 wt. %, 0.05 wt. %, 0.1 wt. %) to about 20 wt. % sweetener, accompanied by a fat content of about 14 wt. % to about 39 wt. %, and from about 22 wt. % (e.g., 24 wt. %, 25 wt. %, 27 wt. %) to about 35 wt. % sweetener, accompanied by a fat content in the range of about 22 wt. % to 39 wt. %. As used, the term “sweetener” refers to all of the sugars and all of the sweeteners present by weight in the fat continuous confection. Due to consumer sensitivity around sugar alcohols and requirement for separate warnings on labels, the fat continuous confections herein advantageously do not include sugar alcohol sweeteners. Notably, in some implementations, the fat continuous confections include no sweetener at al. Exemplary sweeteners that may be used in the methods described herein include, for example, sucrose, glucose, lactose, fructose, maltose, isomaltose, isomaltulose, and trehalose. In some implementations, the sweetener and or sugar(s) of the fat continuous confection is a non-sugar alcohol. Exemplary non-sugar alcohols that may be used include, but are not limited to allulose, arabinose, xylose, sorbose, tagatose, ribose, rhamnose, allose, mannose, cellobiose, kojibiose, nigerose, xylobiose, mannobiose, inulobiose, leucrose, turanose, maltulose, trehalulose, stevia, monkfruit, monkfruit juice solids, sucralose, aspartame, Ace-K, neotame, and saccharin. steviol glycoside, rebaudiosides (e.g. A, B, C, D, E, F, M, N, O), dulcoside A, rubusoside, steviolbioside, mogroside IV, mogroside V, Luo Han Guo sweetener, fruit or juice, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside.

In certain embodiments, the sweetener included in the fat continuous confection has a particle size D₉₀ of up to about 85 microns (e.g., between about 2 microns and about 120 microns) that provides for a fat continuous confection with smooth mouthfeel that is pleasing to consumers. Notably, if the particle size of the sugar is too fine, then too much fat may be needed to ensure satisfactory organoleptic properties of the crème. On the other hand, if the sugar is too coarse, then the fat continuous confection may become too gritty, which is undesirable by consumers.

In some embodiments, the only dietary fiber in the fat continuous confections is insoluble dietary fiber. As such, the fat continuous confections include from about 24 wt. % to about 56 wt. % total dietary fiber in some embodiments, and from about 24 wt. % to about 86 wt. % total dietary fiber in some embodiments. Notably, in some implementations, the fat continuous confections further include one or more bulking agents that contain soluble dietary fiber, which, as mentioned above, cannot be digested by human enzymes. Such soluble dietary fiber may be intrinsic to the bulking agent, or added.

In some embodiments, the fat continuous confection may include from about 0 wt. % to about 62 wt. % soluble dietary fiber. Commercially available bulking agents rich in soluble fibers that may be used in fat continuous confections according to some embodiments include, but are not limited to: polydextrose, inulin, fructo-oligosaccharides, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, human milk oligosaccharides, 2′-fucosyl lactose, lacto-n-neotetraose, glucan (i.e., glucose containing) oligosaccharides, isomalto-oligosaccharides, cello-oligosaccharides (or cellodextrins), resistant dextrins (e.g., soluble corn fiber, soluble wheat fiber, soluble tapioca fiber), nigero-oligosaccharides, nigerotriose, nigerotetraose, kojitriose, kojitetraose, dextrans, beta glucans, lichenan, and isolichenan, and the like.

As described above, in some embodiments, the fat continuous confection may include from about 24 wt. % to about 86 wt. % insoluble dietary fiber and from about 14 wt. % to about 39 wt. % fat, and from about 0 wt. % to about 20 wt. % sweetener. In other words, the minimum fat content of such fat continuous confections is about 14 wt. %, and the carbohydrate content (which includes insoluble dietary fiber, soluble dietary fiber, and sweetener) of such continuous confections ranges from about 24 wt. % to 86 wt. %. To put it another way, in various embodiments, the fat continuous confections may have a carbohydrate to fat ratio of from about 1.7:1 to about 6:1. In some embodiments, the fat continuous confection may include from about 24 wt. % to about 56 wt. % insoluble dietary fiber and from about 22 wt. % to about 39 wt. % fat, and from about 22 wt. % to about 35 wt. % sweetener. Thus, the minimum fat content of such fat continuous confections is about 22 wt. %, and the carbohydrate content (which includes insoluble dietary fiber, soluble dietary fiber, and sweetener) of such continuous confections ranges from about 46 wt. % to 78 wt. %. To put it another way, in various embodiments, the fat continuous confections may have a carbohydrate to fat ratio of from about 2.1:1 to about 3.5:1. Notably, in some embodiments, the fat continuous confection is completely starch-free.

Additional ingredients may also be included, if desired. For example, coloring ingredients, emulsifiers and flavorants, such as natural and artificial colors, sucrose monoesters, sorbitan esters, polyethoxylated glycols, agar, albumin, casein, glyceryl monostearate, gums, soaps, irish moss, polyglycerol polyricinoleate (PGPR), egg yolk, lecithin, and mixtures thereof, non-fat dairy powders, cocoa, protein powders, dried fruit powders, nutrients such as vitamins, minerals, bioactives such as adaptogens, dietary supplements, etc. The product (crème or chocolate) comprising the fat continuous confection may also contain nuts & seeds (whole or chipped), sprinkles, crisps, wafer & biscuit pieces, dried fruit, & vegetable pieces, etc., as inclusions embedded into the fat continuous confection etc.

Advantages and embodiments of the compositions described herein are further illustrated by the following examples; however, the particular conditions, processing schemes, materials, and amounts thereof recited in these examples should not be construed to unduly limit the overall scope of the contemplated compositions.

All percentages recited herein are by weight unless specified otherwise.

### EXAMPLES

The following examples illustrate the differences in the ingredients and rheological properties of the inventive fat continuous confections (crèmes) and non-continuous confections (e.g., powders). As discussed above, it was surprisingly and unexpectedly discovered by the inventors that fat continuous confections suitable for use as chocolates, crèmes, fillings, frostings, etc. can be successfully prepared while replacing the fat and sugar content with high levels of insoluble dietary fibers that were previously thought to be unachievable in low-fat, low-sugar fat continuous confections.

In the exemplary confectionery compositions listed in Table 3, the insoluble dietary fibers were added via a variety of commercially available bulking agents, some of which are listed below in Table 2. Notably, in Table 2, RS2 refers to High Amylose Maize starch (HM260, Ingredion, Westchester, Ill.); MCC refers to micro crystalline cellulose (UFC100/BA100, J. Rettenmaier USA LP, Schoolcraft, Mich.); MF refers to Maple Fiber (Nouravant™, Renmatix, King of Prussia, Pa.); RS4-Potato refers to Modified Potato starch (Versafibe™ 1490, Ingredion, Westchester, Ill.); RS4-Wheat refers to Modified Wheat starch (Fibersym® RW, MGP Ingredients Inc., Atchison, Kans.), SF refers to Soluble Corn Fiber (Promitor® SCF85, Tate & Lyle, Wapella, Ill.). The specific surface area was calculated using a gas sorption analyzer and Krypton or Nitrogen adsorbates according to Brunauer, Emmett, and Teller (BET) model. All samples were analyzed with Nitrogen first, then samples with surface area under about 0.9 m²/g were re-tested with Krypton as adsorbate. Tristar II (RSSL 7345) was used for the analysis and Micromeritics SmartPrep unit was used for degassing the samples. Degassing was performed as follows: under nitrogen flow, the sample was held at 30° C. for 10 minutes and then at 100° C. for 60 minutes.

TABLE 2
Properties of bulking agents used to prepare FCCs described in Table 3

| Experimental bulking | | | Calories | Oil binding | Specific Surface |
|---|---|---|---|---|---|
| agent name | TDF % | IDF % | (kcal/g) | Capacity | Area m²/g |
| Sucrose, crystalline | 0% | 0% | 3.9 | 0.67 ± 0.01 | 0.99 ± 0.01 |
| RS2:SF = 1:2 composite | 75.7% | 12.4% | 2.0 | 0.44 ± 0.07 | 0.23 ± 0.01 |
| RS2:SF = 1:2 mix | 75.7% | 12.4% | 2.0 | | |
| RS2:SF = 1:1 composite | 68.8% | 18.6% | 2.0 | 0.38 ± 0.08 | 0.23 ± 0.00 |
| RS2:SF = 1:1 mix | 68.8% | 18.6% | 2.0 | | |
| RS2 | 48.0% | 37.1% | 1.7 | 0.43 ± 0.06 | 0.41 ± 0.00 |
| MCC:SF = 1:2 composite | 91.5% | 31.8% | 1.5 | 0.76 ± 0.01 | 0.24 ± 0.03 |
| MCC:SF = 1:2 mix | 91.5% | 31.8% | 1.5 | | |
| MCC:SF = 1:1 composite | 92.5% | 47.8% | 1.1 | 0.93 ± 0.03 | 0.32 ± 0.08 |
| MCC:SF = 1:1 mix | 92.5% | 47.8% | 1.1 | | |
| MCC | 95.5% | 95.5% | 0.0 | 2.01 ± 0.02 | 4.39 ± 0.54 |
| MF:SF = 1:2 composite | 90.2% | 26.9% | 1.5 | | |
| MF:SF = 1:1 composite | 90.5% | 40.4% | 1.2 | | |
| MF:SF = 2:1 composite | 90.8% | 53.9% | 0.9 | | |
| MF:SF = 1:0 (dried MF) | 91.5% | 80.8% | 0.2 | | |
| Defatted Cocoa Powder | 38.0% | 37.0% | 1.3 | | |
| Oat Fiber | 85.3% | 84.9% | 0.2 | | |
| Oat Fiber | 89.3% | 89.2% | 0.1 | | |
| Wheat Fiber | 94.0% | 93.0% | 0.1 | 1.91 ± 0.01 | 1.63 ± 0.29 |
| RS4-Potato | 74.3% | 74.3% | 0.41 | | 0.13 ± 0.00 |
| RS4-Wheat | 80.6% | 79.6% | 0.35 | | 0.32 ± 0.00 |

The oil binding capacity of the samples was calculated as follows. First, 4 g of a sample was added to 20 ml of sunflower oil in 50 ml centrifuge tubes, and the tubes were inverted at the time of addition (samples prepared in duplicate). Then, the contents were mixed for one minute using a vortex mixer. The tubes were then allowed to incubate for a total time of 30 mins (including mixing time). After that, the tubes were centrifuged at 25° C., 1600×g for 25 min. Then, the free oil was decanted and the tubes were held at approximately a 45° angle and the residual oil was allowed to drain off for 25 min and the resulting pellet was weighed. The oil binding capacity was expressed as g absorbed oil per g sample (g/g) (initial weight−pellet weight).

The samples in Table 3 below were prepared as follows. A control crème formulation (2 parts carb to 1 part fat) was prepared by mixing 14 g Domino icing sugar with 7 g SansTrans™ HIFT-15 palm fat (Bunge Loders Croaklaan, Channahon, Ill.) in a Flack Tek mixer at 2400 rpm for 45 seconds. To create samples with sugar and fat replacements, appropriate amounts of sugar and fat in the control formulation were replaced by a bulking agent. The exact inventive and comparative formulations are shown in the leftmost column in Table 3 below. In Table 3 below, the term “Comp” refers to comparative confections, the term “Inv” refers to inventive fat continuous confections, the term “FCC” refers to fat continuous confection, the term “composite” denotes composite bulking agent particles that were created by combining the soluble dietary fiber with the insoluble dietary fiber particles to at least partially coat the insoluble dietary fiber particles with the soluble dietary fiber (e.g., by spray-drying), the abbreviation “carb” denotes carbohydrate, the abbreviation “TDF” refers to total dietary fiber, the abbreviation “IDF” refers to insoluble dietary fiber, the abbreviation “Cal” refers to calories, the abbreviation “n/a” refers to not available, and the acronym “TMA” denotes thermomechanical analyzer.

TABLE 3
List of Exemplary Inventive Samples and Comparative Samples

| Sample | Sample | Bulking | | | | | Visual | TMA |
|---|---|---|---|---|---|---|---|---|
| Name | Formulation | agent used | Carb:Fat | TDF/IDF/Cal | Sweetener | Fat | FCC? | FCC? |
| Comp | fat 7 g | sucrose, | 2:1 | 0/0/5.6 | 67% | 33% | y | y |
| CE-Sugar | sugar 14 g | crystalline | | | | | | |
| FCC | | | | | | | | |
| # 1 | | | | | | | | |
| Comp | fat 5.25 g | sucrose, | 3:1 | 0/0/5.1 | 75% | 25% | y | n/a |
| CE-Sugar | sugar 15.75 g | crystalline | | | | | | |
| FCC | | | | | | | | |
| # 2 | | | | | | | | |
| Comp | fat 4.62 g | sucrose, | 3.5:1 | 0/0/5.0 | 78% | 22% | n | n/a |
| CE-Sugar | sugar 16.38 g | crystalline | | | | | | |
| Powder | | | | | | | | |
| # 1 | | | | | | | | |
| Comp | fat 7 g | Defatted | 2:1 | 25%/25%/3.9 | 0% | 33.3% | n | n/a |
| CE-Powder | sugar 0 g | cocoa | | | | | | |
| # 2 | bulking | powder | | | | | | |
| | agent 14 g | | | | | | | |
| Comp | fat 7 g | Oat Fiber | 2:1 | 45%/45%/3.7 | 17% | 23.3% | n | n/a |
| CE-Powder | sugar 3.5 g | | | | | | | |
| # 3 | bulking | | | | | | | |
| | agent 10.5 g | | | | | | | |
| Comp | fat 7 g | Wheat | 2:1 | 22%/22%/4.7 | 43% | 33.3% | n | n/a |
| CE-Powder | sugar 9.1 g | Fiber | | | | | | |
| # 4 | bulking | | | | | | | |
| | agent 4.9 g | | | | | | | |
| Comp | fat 10 g | MCC | 1.1:1 | 25%/25%/5.3 | 26% | 47.6% | y | y |
| 1- CE FCC | sugar 5.5 g | | | | | | | |
| | bulking | | | | | | | |
| | agent 5.5 g | | | | | | | |
| Comp | fat 9 g | MCC | 1.2:1 | 31%/31%/4.8 | 25% | 42.9% | y | y |
| 2A-CE FCC | sugar 5.25 g | | | | | | | |
| | bulking | | | | | | | |
| | agent 6.75 g | | | | | | | |
| Comp | fat 8.5 g | MCC | 1.5:1 | 33%/33%/4.6 | 25% | 40.5% | y | y |
| 2C-CE FCC | sugar 5.25 g | | | | | | | |
| | bulking | | | | | | | |
| | agent 7.25 g | | | | | | | |
| Comp | fat 8 g | MCC | 1.6:1 | 35%/35%/4.0 | 25% | 38.1% | n | n |
| 2-CE | sugar 5.25 g | | | | | | | |
| Powder | bulking | | | | | | | |
| | agent 7.75 g | | | | | | | |
| Inv | fat 5.25 g | MCC:SF = | 3:1 | 69%/24%/3.4 | 0% | 25.0% | y | n/a |
| 8-Example | sugar 0 g | 1:2 | | | | | | |
| FCC | bulking | composite | | | | | | |
| | agent 15.75 g | | | | | | | |
| Inv | fat 7 g | MCC:SF = | 2:1 | 46%/24%/4.2 | 17% | 33.3% | y | y |
| 7-Example | sugar 3.5 g | 1:1 | | | | | | |
| FCC | bulking | composite | | | | | | |
| | agent 10.5 g | | | | | | | |
| Comp | fat 7 g | MCC:SF = | 2:1 | 46%/24%/4.2 | 17% | 33.3% | n | n |
| 7-CE | sugar 3.5 g | 1:1 mix | | | | | | |
| Powder | bulking | | | | | | | |
| | agent 10.5 g | | | | | | | |
| Inv | fat 7 g | MCC:SF = | 2:1 | 52%/27%/4.0 | 10% | 33.3% | y | n/a |
| 6-Example | sugar 2.1 g | 1:1 | | | | | | |
| FCC | bulking | composite | | | | | | |
| | agent 11.9 g | | | | | | | |
| Comp | fat 7 g | MCC:SF = | 2:1 | 62%/32%/3.7 | 0% | 33.3% | n | n |
| 1-CE | sugar 0 g | 1:1 mix | | | | | | |
| Powder | bulking | | | | | | | |
| | agent 14 g | | | | | | | |
| Inv | fat 7 g | MCC:SF = | 2:1 | 62%/32%/3.7 | 0% | 33.3% | y | y |
| 1-Example | sugar 0 g | 1:1 | | | | | | |
| FCC | bulking | composite | | | | | | |
| | agent 14 g | | | | | | | |
| Comp | fat 3 g | RS2 | 6:1 | 29%/23%/3.3 | 25% | 14.3% | n | n |
| 6-CE | sugar 5.25 g | | | | | | | |
| Powder | bulking | | | | | | | |
| | agent 12.75 g | | | | | | | |
| Inv | fat 7 g | RS2 | 2:1 | 32%/25%/4.1 | 0% | 33.3% | y | n/a |
| 10-Example | sugar 0 g | | | | | | | |
| FCC | bulking | | | | | | | |
| | agent 14 g | | | | | | | |
| Inv | fat 6 g | RS2 | 2.5:1 | 34%/27%/3.8 | 0% | 28.6% | y | n/a |
| 5-Example | sugar 0 g | | | | | | | |
| FCC | bulking | | | | | | | |
| | agent 15 g | | | | | | | |
| Inv | fat 7 g | MF:SF = | 2:1 | 61%/54%/3.1 | 0% | 33.3% | y | n/a |
| 2-Example | sugar 0 g | 1:0 | | | | | | |
| FCC | bulking | (dried MF) | | | | | | |
| | agent 14 g | | | | | | | |
| Inv | fat 7 g | MF:SF = | 2:1 | 60%/27%/3.8 | 0% | 33.3% | y | n/a |
| 11-Example | sugar 0 g | 1:1 | | | | | | |
| FCC | bulking | composite | | | | | | |
| | agent 14 g | | | | | | | |
| Inv | fat 5.25 g | MF:SF = | 3:1 | 68%/40%/2.9 | 0% | 25.0% | y | y |
| 4-Example | sugar 0 g | 2:1 | | | | | | |
| FCC | bulking | composite | | | | | | |
| | agent 15.75 g | | | | | | | |
| Inv | fat 5.25 g | RS4 | 3:1 | 56%/56%/2.6 | 0% | 25.0% | y | n/a |
| 9-Example | sugar 0 g | Potato | | | | | | |
| FCC | bulking | | | | | | | |
| | agent 15.75 g | | | | | | | |
| Inv | fat 3 g | RS4 | 6:1 | 64%/64%/1.6 | 0% | 14.3% | y | y |
| 3-Example | sugar 0 g | Potato | | | | | | |
| FCC | bulking | | | | | | | |
| | agent 18 g | | | | | | | |
| Comp | fat 2.8 g | RS4 | 6.5:1 | 64%/64%/1.6 | 0% | 13.3% | n | n |
| 4-CE | sugar 0 g | Potato | | | | | | |
| Powder | bulking | | | | | | | |
| | agent 18.2 g | | | | | | | |
| Comp | fat 3 g | RS4 | 6:1 | 45%/45%/2.5 | 25% | 14.3% | n | n |
| 5-CE | sugar 5.25 g | Potato | | | | | | |
| Powder | bulking | | | | | | | |
| | agent 12.75 g | | | | | | | |
| Inv | fat 3.6 g | RS4 | 4.8:1 | 50%/50%/2.4 | 15% | 17.1% | y | n/a |
| 12-Example | sugar 3.15 g | Potato | | | | | | |
| FCC | bulking | | | | | | | |
| | agent 14.25 g | | | | | | | |
| Inv | fat 3.6 g | RS4 | 4.8:1 | 47%/47%/2.6 | 20% | 17.1% | y | n/a |
| 13-Example | sugar 4.2 g | Potato | | | | | | |
| FCC | bulking | | | | | | | |
| | agent 13.2 g | | | | | | | |
| Inv | fat 3.9 g | RS4 | 4.4:1 | 46%/46%/2.7 | 20% | 18.6% | y | n/a |
| 14-Example | sugar 4.2 g | Potato | | | | | | |
| FCC | bulking | | | | | | | |
| | agent 12.9 g | | | | | | | |
| Comp | fat 3.9 g | RS4 | 4.4:1 | 42%/42%/2.9 | 25% | 18.6% | n | n/a |
| 15-CE | sugar 5.25 g | Potato | | | | | | |
| Powder | bulking | | | | | | | |
| | agent 11.85 g | | | | | | | |
| Comp | fat 4.2 g | RS4 | 4:1 | 44%/44%/3.0 | 25% | 20% | n | n/a |
| C-CE | sugar 5.25 g | Wheat | | | | | | |
| Powder | bulking | | | | | | | |
| | agent 11.55 g | | | | | | | |
| Inv | fat 4.62 g | RS4 | 3.5:1 | 42%/42%/3.1 | 22% | 22% | y | n/a |
| A-Example | sugar 4.62 g | Potato | | | | | | |
| FCC | bulking | | | | | | | |
| | agent 11.76 g | | | | | | | |
| Inv | fat 4.62 g | RS4 | 3.5:1 | 32%/32%/3.5 | 35% | 22% | y | n/a |
| B-Example | sugar 7.35 g | Potato | | | | | | |
| FCC | bulking | | | | | | | |
| | agent 9.03 g | | | | | | | |
| Inv | fat 5.25 g | RS4 | 3:1 | 40%/40%/3.4 | 25% | 25% | y | n/a |
| D-Example | sugar 5.25 g | Wheat | | | | | | |
| FCC | bulking | | | | | | | |
| | agent 10.5 g | | | | | | | |
| Inv | fat 5.25 g | RS4 | 3:1 | 37%/37%/3.4 | 25% | 25% | y | n/a |
| 16-Example | sugar 5.25 g | Potato | | | | | | |
| FCC | bulking | | | | | | | |
| | agent 10.5 g | | | | | | | |
| Inv | fat 8.15 g | RS4 | 1.6:1 | 29%/29%/4.6 | 25% | 38.8% | y | n/a |
| E-Example | sugar 5.25g | Wheat | | | | | | |
| FCC | bulking | | | | | | | |
| | agent 7.6 g | | | | | | | |
| Comp | fat 3 g | RS4 | 4.8:1 | 41%/40%/2.8 | 35% | 14.3% | n | n/a |
| F-CE | sugar 7.35 g | Wheat | | | | | | |
| Powder | bulking | | | | | | | |
| | agent 10.65 g | | | | | | | |
| Comp | fat 4.2 g | RS4 | 4:1 | 36%/36%/3.3 | 35% | 20% | n | n/a |
| G-CE | sugar 7.35 g | Wheat | | | | | | |
| Powder | bulking | | | | | | | |
| | agent 9.45 g | | | | | | | |
| Inv | fat 7 g | RS4 | 2:1 | 27%/27%/4.4 | 33.3% | 33.3% | y | n/a |
| H-Example | sugar 7 g | Wheat | | | | | | |
| FCC | bulking | | | | | | | |
| | agent 7 g | | | | | | | |
| Inv | refiner | MF:SF = | 2.6 | 38.7%/24.3%/3.4 | 25.3% | 27% | y | n/a |
| Milk Choc | paste 36.5 g | 2:1 | | | | | | |
| Example | cocoa | composite | | | | | | |
| FCC | butter 4.3 g | | | | | | | |
| | PGPR 0.6 g | | | | | | | |
| | sugar 20.5 g | | | | | | | |
| | bulking | | | | | | | |
| | agent 39 g | | | | | | | |
| Inv | Cocoa butter | MF:SF = | 2.3 | 54.4%/25.3%/3.2 | 7% | 30.0% | y | n/a |
| Dark Choc | 24.5 g | 1:1 | | | | | | |
| Example | cocoa liquor | composite | | | | | | |
| FCC | 10 g | | | | | | | |
| | PGPR 0.5 g | | | | | | | |
| | sugar 7 g | | | | | | | |
| | bulking | | | | | | | |
| | agent 58 g | | | | | | | |

The evaluation of whether the use of the different bulking agents at target insoluble dietary fiber levels (i.e., 24-86 wt. %) yielded a fat continuous confection, or a discontinuous confection is critical to commercial usefulness of the final product. In particular, as explained above, fat continuous confections, such as crèmes, chocolates, icings, fillings etc., are commercially-desired products, while granular powder-like products are much more limited in confectionery application.

All samples in Table 3 above were visually inspected as follows to determine whether the sample represents a crème-like fat continuous confection or a powder-like discontinuous confection: 1 day after making the confection as described above (21 g crème sample), the container was inverted on a bench and allowed to sit for 15 seconds. If more than 1 wt. % of material (i.e., more than 0.21 g) was found to drop onto the lid, then the sample was deemed not continuous (i.e. “n”), otherwise it was deemed continuous (i.e., “y”). If upon visual observation, a sample appeared to be continuous and could be clearly scooped with a spoon, but marginally failed the test (e.g., more than 1 wt. % but less than 5 wt. % of material dropped onto the lid) the sample was prepared once again and re-tested to determine continuity/discontinuity.

In Table 3, comparative samples CE-Sugar FCC #1, CE-Sugar FCC #2, and CE-Sugar Powder #1 appear to indicate that more than 22 wt. % fat is needed to make a simple fat/sugar fat continuous confection without the use of any dietary fiber. The comparative samples CE-Powder #2, CE-Powder #3, and CE-Powder #4 in Table 3 indicate that, for compositions containing from about 23 wt. % fat to about 33 wt. % fat, simply replacing all or part of the sugar with commercially available fibers (including from 22 wt. % to 45 wt. % insoluble dietary fibers) did not yield fat continuous confections. The comparative samples 1-CE FCC, 2A-FCC, and 2C FCC indicate that, for confections including at least 25 wt. % insoluble dietary fiber and at least 25 wt. % sugar, one way to produce a fat continuous confection is to add fat in an amount of at least about 40 wt. %.

Table 3 also indicates that, for confections including at least 24 wt. % insoluble dietary fiber and from 0 wt. % to 17 wt. % sugar, and under 40 wt. % fat, simply mixing in commercially available bulking agents did not result in fat continuous confections (see comparative samples 1-CE Powder and 7-CE Powder), while using bulking agents made up of spray-dried composite particles (i.e., insoluble dietary fiber core that is at least in part coated by a soluble dietary fiber shell) having a reduced specific surface area of less than about 1 m²/g resulted in fat continuous confections (see inventive samples 1-Example FCC, 6-Example FCC, 7-Example FCC, and 8-Example FCC). Notably, inventive samples 5-Example FCC and 10-Example FCC indicate that, for confections including no added sugar, 25 wt. % or more insoluble dietary fiber, and under 40 wt. % fat, using a bulking agent having a low specific surface area of less than about 1 m²/g (i.e., RS2) resulted in a fat continuous confection, while comparative sample 6-CE Powder indicates that using RS2 as a bulking agent in a confection having 25 wt. % sugar, just under 24 wt. % insoluble dietary fiber, and under 40 wt. % fat did not result in a fat continuous confection. In addition, as will be discussed below in more detail, a comparison between inventive sample 3-Example FCC and 4-CE Powder indicates that the presence of at least about 14 wt. % fat is necessary for a sample having a high level of insoluble dietary fibers and no sugars to form a fat continuous confection.

The general principles of a rheological test is that, unlike a powder confection, the rheological properties of a true fat continuous confection are driven by the state of the fat. In other words, if a fat continuous confection were to be heated to a temperature at which the fat melts completely, the fat continuous confection would be able to flow akin to melted crème or molten chocolate. Then, upon cooling, if the fat partially solidifies, the entire fat continuous confection would achieve a soft-textured consistency (i.e., crème state) similar to a paste or icing. If the fat continuous confection were cooled to a temperature at which the fat phase solidifies further, then, by virtue of being a continuous system, the entire fat continuous confection would become firm in texture akin to chocolate. In contrast, in the case of powder confections, when the fat solidifies significantly upon cooling, the powder confection is still relatively soft, as the individual particles are still able to flow past each other similar to “dippin dots.”

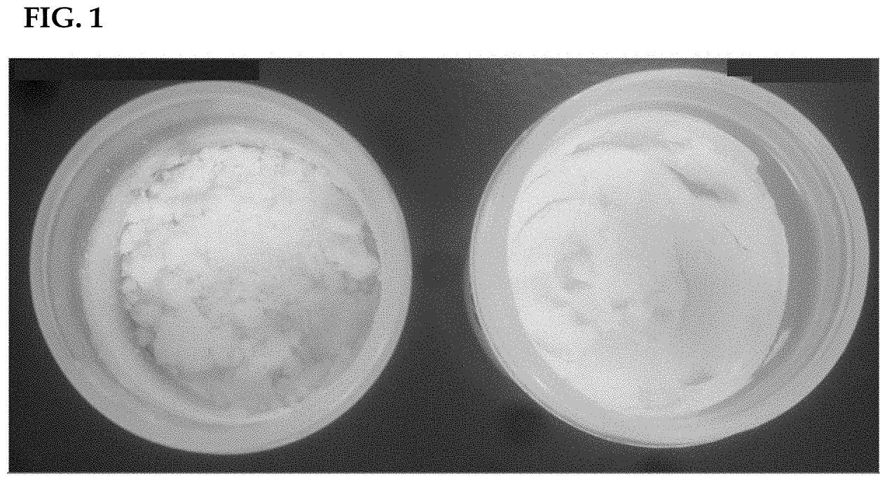

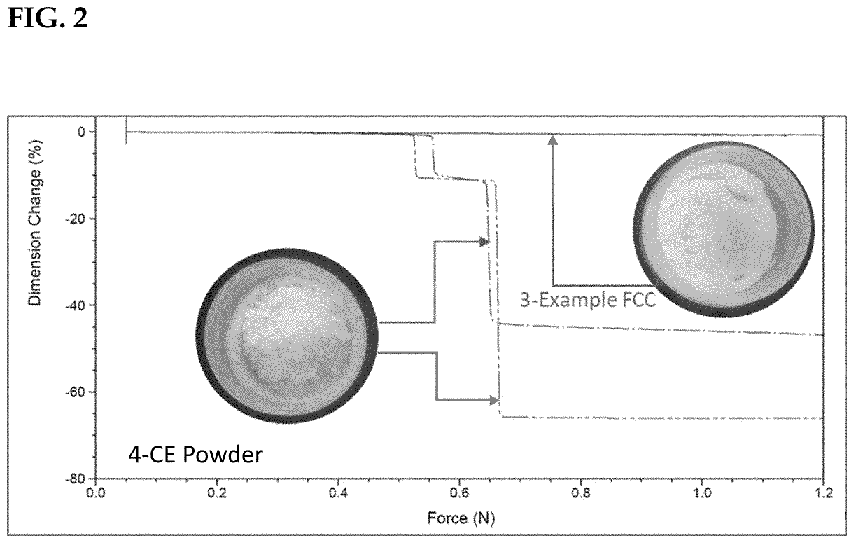

With reference to FIG. 1, it is clear that in a fat continuous confection (i.e., inventive sample 3-Example FCC on the right-hand side), the entire mass is one continuous crème, where the insoluble fiber (bulking agent) and/or sweetener particles are suspended in a continuous fat phase. As can be seen in FIG. 2, the thermomechanical properties of such a fat continuous confection were observed (using a thermomechanical analyzer as described in more detail below) to be as follows: when the fat solidifies, the entire fat continuous confection solidifies. Upon increasing force, the solidified fat continuous confection gives very little yield. Furthermore, the yield curve in the solid state (plot of force vs. % dimension change) is continuous for 3-Example FCC. On the other hand, in the case of a powder (i.e., comparative sample 4-CE Powder on the left-hand side), the entire mass consists of discontinuous powder particles which separate easily, and the powder does not hold together as a product. FIG. 2 shows that the thermomechanical properties of such a discontinuous confection were observed to be as follows: when the fat solidifies, the powder confection is still relatively soft, whence with increasing force the individual particles are still able to flow past each other (similar to “dippin dots”), resulting in a discontinuous yield curve.

The properties of some (but not all) of the samples obtained in Table 3 were not just visually inspected as described above, but were further subjected to rheological testing using a thermomechanical analyzer (TMA). Generally, thermomechanical analysis is a technique which studies the properties of materials as they change in response to variations in temperature and applied force. A typical thermomechanical analyzer test monitors the deformation of a sample under non-oscillating stress (e.g., compression, tension, flexure, or torsion) against time or temperature. The instrument used for rheological testing of the samples in Table 3 was TA Instruments model Q400EM Thermomechanical Analyzer, equipped with a mechanical cooling accessory model MCA 70, and a hemispherical quartz probe. The test procedure was as follows: a sample size of 150±2 mg was placed in a sample glass cup having an internal diameter of 8 mm, the thermomechanical analyzer was set to a preload force of 0.05N, equilibration at 0° C., isothermal 5 min, ramp force at 0.2 N/min to 1.6 N, and length of travel of the probe (which indicates sample deformation) was measured.

FIG. 2 illustrates a thermomechanical analyzer-generated plot of % dimension change vs. force for 4-CE Powder (broken double dash line, red) and 3-Example FCC (solid line, green) with 2 replicates. FIG. 2 illustrates the differences in rheological behavior of a powder (4-CE Powder in Table 3) and a fat continuous confection (3-Example FCC in Table 3) when subjected to a force ramp as per the test procedure, at a temperature of 0° C. Notably, the palm fat used in these crèmes (i.e., SansTrans™ HFT-15), is expected to contain more than 50% solids at this temperature (based on its solid fat crystallization curve).

As can be seen in FIG. 2, being a discontinuous powder, comparative sample 4-CE Powder initially resists deformation, but as the load increases, it shows significant (greater than 5%) deformation/dimension change. In addition, FIG. 2 shows that the dimension change happens discontinuously, suggesting that the probe slips between the particles, as is expected in the case of a mass of discontinuous powder particles coated with fat. On the other hand, inventive sample 3-Example FCC shows very little deformation/dimension change (i.e., under 5%) throughout the test. More importantly, even the minimal deformation that does occur in sample 3-Example FCC, which is a fat continuous confection, is continuous, suggesting that the entire sample behaves as a single, fat continuous mass, the rheological behavior of which is governed by the fat.

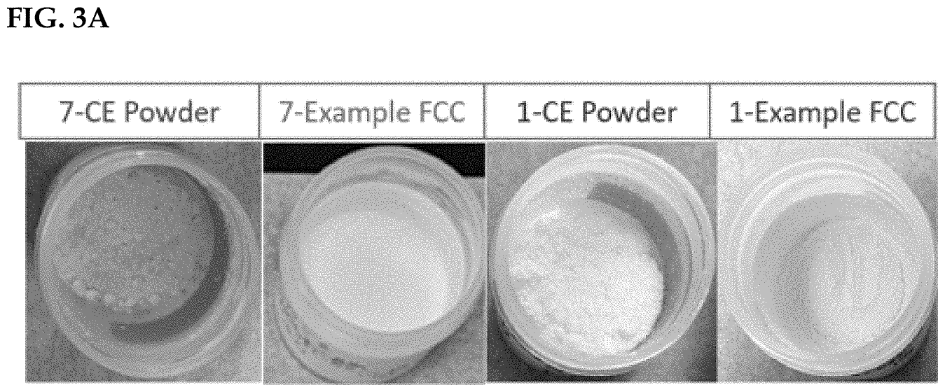

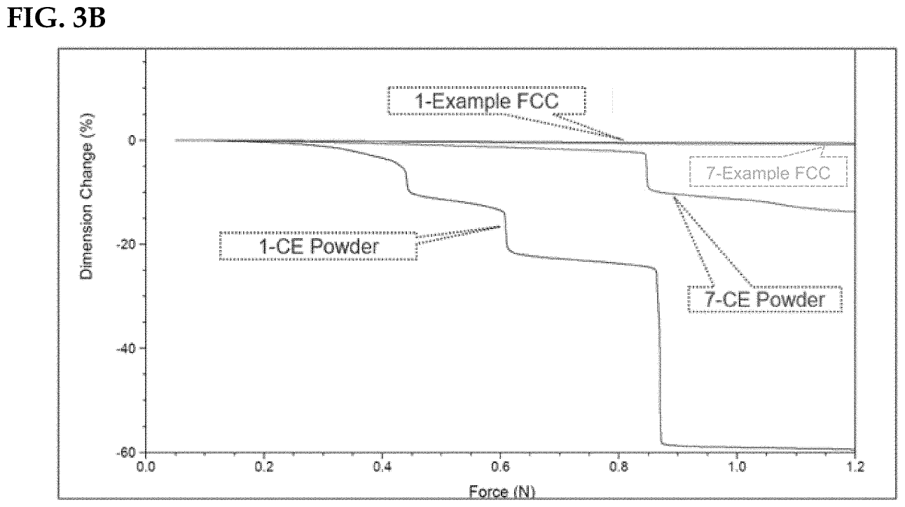

FIG. 3A shows photographs comparing selected inventive fat continuous confections (1-Example FCC and 7-Example FCC) from Table 3 with selected comparative discontinuous powders (1-CE Powder and 7-CE Powder) from Table 3 having substantially similar compositions. As can been seen in FIG. 3A, inventive samples 1-Example FCC and 7-Example are in the form of a smooth crème-like fat continuous mass, while comparative samples 1-CE Powder and 7-CE Powder are in the form of a granular, discontinuous mass of powder-like particles. FIG. 3B illustrates a thermomechanical analyzer-generated plot of % dimension change vs. force of the inventive fat continuous confections and comparative powders depicted in FIG. 3A.

As can be seen in FIG. 3B, during the thermomechanical analyzer test, the discontinuous comparative samples 1-CE Powder and 7-CE Powder exhibit rheological properties (significant dimension change) akin to the comparative sample 4-CE Powder in FIG. 2, while the inventive fat continuous confection samples 1-Example FCC and 7-Example FCC exhibit rheological properties (i.e., insignificant dimension change) akin to the inventive fat continuous confection sample 3-Example FCC in FIG. 2. In combination, FIGS. 3A-3B clearly show the visual differences and the rheological property differences between inventive fat continuous confections and comparative discontinuous powders that otherwise have a substantially identical chemical and nutritional composition.

In particular, comparative sample 1-CE Powder and inventive sample 1-Example FCC were prepared according to the sample preparation procedure described above, and each included 7 g fat, 0 g sugar, and 14 g bulking agent, and contained 32 wt. % insoluble dietary fiber, 62 wt. % total dietary fiber, 0 wt. % sweetener, and 33.3 wt. % fat. Similarly, comparative sample 7-CE Powder and inventive sample 7-Example FCC were prepared according to the sample preparation procedure described above, and each included 7 g fat, 3.5 g sugar, and 10.5 g bulking agent, and contained 24 wt. % insoluble dietary fiber, 46 wt. % total dietary fiber, 17 wt. % sweetener, and 33.3 wt. % fat. The bulking agent used for all four of these samples was a 1:1 ratio of soluble fiber (Promitor® SCF85) and insoluble fiber (micro crystalline cellulose), and all four samples used the same level of the bulking agent.

However, in the case of the comparative samples 1-CE Powder and 7-CE Powder, the soluble and insoluble components of the bulking agent were simply mixed in the dry state, while in the case of the inventive samples 1-Example FCC and 7-Example FCC, the soluble fiber was combined with the insoluble fiber particles to create “composite” particles. Thus, the present inventors surprisingly and unexpectedly found that combining the soluble and insoluble fiber components of the bulking agent to form “composite” particles where the insoluble dietary fiber particles are at least in part coated (e.g., partially or fully enrobed) by soluble dietary fiber unexpectedly and advantageously leads to significant surface area reduction relative to the insoluble fiber component (i.e., microcrystalline cellulose), which then decreases the oil binding capacity of the sample.

For example, in some embodiments, the specific surface area of the composite particles is from about 0.05 m²/g to about 1 m²/g, and the aspect ratio (i.e., ratio of the width to length) of the composite particles ranges from 0 to 1 (with the aspect ratio of 1 being a perfect circle). In some embodiments, the composite particles have a size distribution D90 of 10 microns to 85 microns. Notably, as used herein, the term “particle size distribution D90” refers to the 90th percentile value by volume of the particle size distribution. That is, the D90 is a value on the particle size distribution, where 90% by volume of the particles have a size of this value or less.

In one approach, composite particles having a generally round shape and having a core made of insoluble dietary fiber (forming from at least 30 wt. % to at least 50 wt. % of the composite particle) and a shell (at least partially or fully enrobing the core) made of soluble dietary fiber (or, optionally, of other soluble materials such as sugar) were prepared by spray-drying the soluble dietary fiber onto the insoluble dietary fiber particles. As such, it was unexpectedly and surprisingly found by the inventors that, depending on whether the components of the bulking agents are simply mixed, or treated (e.g., by spray-drying) to create composite particles having a core of insoluble fiber particles and a shell of soluble fiber, the same bulking agents can be used to create either an advantageous fat continuous confection, or a less advantageous powder confection, which appear differently in the visual observation test and perform differently during the thermomechanical analyzer test.

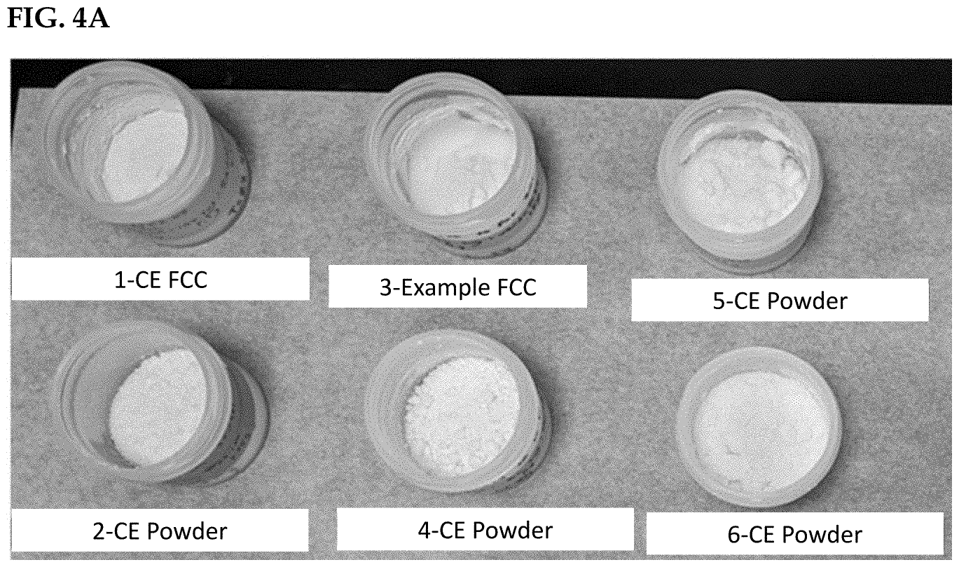

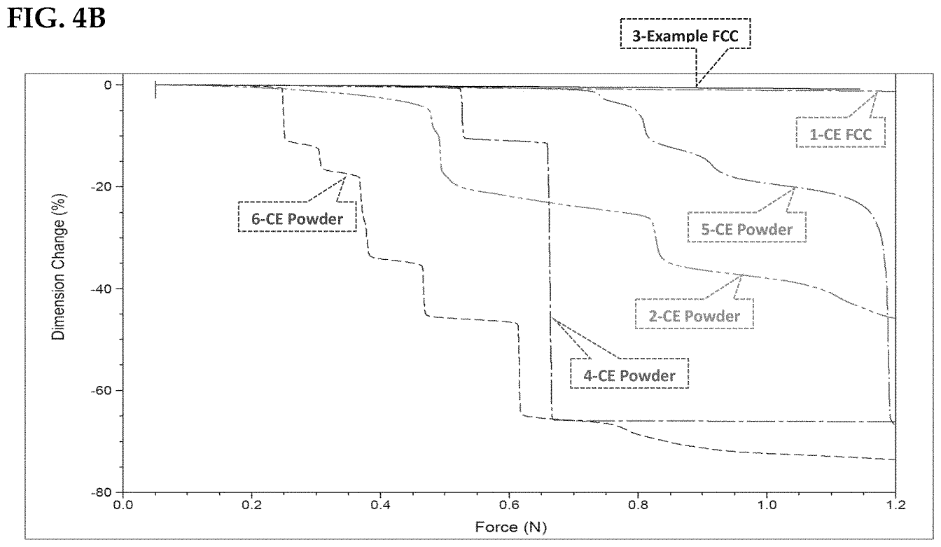

FIG. 4A shows photographs comparing several selected samples from Table 3, namely, two fat continuous confections (i.e., comparative sample 1-CE FCC and inventive sample 3-Example FCC) with four respective discontinuous powders of similar composition (comparative samples 2-CE Powder, 4-CE Powder, 5-CE Powder, and 6-CE Powder). FIG. 4B shows a thermomechanical plot of % dimension change vs. force of the samples in FIG. 4A, illustrating the rheological property differences between the crème-like fat continuous samples and the discontinuous powder-like samples.

As discussed above, providing a low-fat, low-calorie, low-sugar fat continuous confection with an increased high insoluble dietary fiber content (from about 24-86 wt. % in some embodiments and from about 24-56 wt. % in other embodiments) and decreased fat content (from about 14-39 wt. % in some embodiments and from about 22-39 wt. % in other embodiments) and decreased sugar content (from about 0-20 wt. % in some embodiments and from about 22-35 wt. % in other embodiments) is a primary advantage achieved by the present inventors. On the other hand, comparative sample 1-CE FCC, which includes 25 wt. % insoluble dietary fiber and a 26 wt. % sweetener (crystalline sucrose) successfully yields a fat continuous confection as seen in FIG. 4A, but includes significantly more fat (i.e., 47.6 wt. %). In contrast, none of the inventive samples in Table 3 exceed 39 wt. % fat and advantageously achieve a lower calorie content (at most 4.2 kcal/g) relative to the higher-fat comparative samples (e.g., comparative sample 1-CE FCC has a calorie content of 5.3 kcal/g), while the lowest calorie comparative fat continuous confection having at least 24% insoluble dairy fiber is 2C-CE FCC, which has 4.6 kcal.

Notably, comparative sample 2-CE Powder, which is similar to comparative sample 2C-CE FCC in that it contains a similar level of insoluble dietary fiber (35 wt. % compared to 33 wt. %) and 25 wt. % sweetener, but is different from 2C-CE FCC in that it contains less than 40 (i.e., 38.1) wt. % fat, did not successfully form a fat continuous confection. This finding suggests that confections having more than 24 wt. % insoluble fiber, 25 or more wt. % sweetener, and less than 40 wt. % fat do not successfully form a fat continuous confection absent the use of a bulking agent comprising composite particles having insoluble fiber particles combined with and/or at least partly coated by soluble fiber as described above. It should also be noted that this finding can be confirmed notwithstanding the sweetener content of the composition by looking at the fact that comparative sample 7-CE Powder, which contains 24 wt. % insoluble dietary powder, 17 wt. % sweetener and 33 wt. % fat did not successfully form a fat continuous confection, and the fact that comparative sample CE-Powder #2, which contains 25 wt. % insoluble dietary powder, 0 wt. % sweetener and 33 wt. % fat also did not successfully form a fat continuous confection.

A comparison of the ingredients of inventive sample 3-Example FCC and comparative sample 4-CE Powder in Table 3 appears to indicate that the presence of at least about 14 wt. % fat is critical to the formation of a fat continuous confection. In particular, the formulation of the samples is almost identical, with inventive sample 3-Example FCC including 3 g fat, 0 g sugar, and 18 g bulking agent and comparative sample 4-CE Powder including 2.8 g fat, 0 g sugar, and 18.2 g bulking agent. Notably, with reference back to Table 3, the bulking agent used for both samples was RS4-Potato, and each sample included 64 wt. % insoluble dietary fiber, 64 wt. % total dietary fiber, and 0 wt. % sweetener, with the main difference between the samples being their fat content. In particular, inventive sample 3-Example FCC contained over 14 wt. % (i.e., 14.3 wt. %) fat, and comparative sample 4-CE Powder contained under 14 wt. % (i.e., 13.3 wt. %) fat. As such, the presence of 14 wt. % fat appears to be critical to the formation of a fat continuous confection in samples that include over 24 wt. % insoluble dietary fiber and no sweetener, since the presence of 14.3 wt. % fat in sample 3-Example FCC yielded a crème-like fat continuous confection, and the presence of 13.3 wt. % fat (i.e., a deficiency of just 0.7 wt. % relative to 14 wt. %) in sample 4-CE Powder yielded a powder-like discontinuous confection.

As indicated in Table 3 and further shown in FIGS. 4A-4B, this difference in fat content of these two samples resulted in a significant property variation between them. In particular, FIG. 4A shows that inventive sample 3-Example FCC turned out to be a crème-like fat continuous confection, while comparative sample 4-CE Powder turned out to be a discontinuous powder-like continuous confection. FIG. 4B shows the difference in rheological properties of these two samples, with the comparative sample 4-CE Powder (which is discontinuous) exhibiting a significant dimension change across the applied force spectrum, and the inventive sample 3-Example FCC (which is fat continuous) exhibiting an insignificant dimension change across the applied force spectrum. In combination, FIGS. 4A-4B clearly show the visual differences and the rheological property differences between the fat continuous confection sample 3-Example FCC and the discontinuous powder sample 4-CE Powder that are different in their fat content (one being slightly above 14 wt. % and one being slightly below 14 wt. %), but otherwise have a substantially identical chemical and nutritional composition.

Furthermore, a comparison of inventive sample 3-Example FCC with comparative sample 5-CE Powder and 6-CE Powder shows that even when the fat content of the sample is above 14 wt. % (i.e., both samples have 14.3 wt. % fat) and the amount of the insoluble fiber content is above 24 wt. % (64 wt. % in 3-Example FCC and 45 wt. % in 5-CE Powder), the amount of sweetener plays an important role in determining whether the composition is a fat continuous confection, or a discontinuous powdery mass. In particular, inventive sample 3-Example FCC and comparative sample 5-CE Powder both used the same bulking agent (RS4-Potato), but in the latter case, a portion of the bulking agent was replaced with a sweetener (i.e., crystalline sucrose) to raise the sweetener level to above 20 wt. % (i.e., to 25 wt. %), resulting in a failure to form a fat continuous confection, as indicated in Table 3 and confirmed by the visual observation test results shown in FIG. 4A, as well as the thermomechanical analyzer test results shown in FIG. 4B.

Notably, Table 3 above includes not only exemplary fat continuous confections in the form of crèmes, but also includes two exemplary inventive fat continuous confections in the form of chocolate that may be achieved, namely, a milk chocolate (Milk Choc Example FCC) and a dark chocolate (Dark Choc Example FCC). The formulation of the milk chocolate sample was as follows: 36.5 g refiner paste (13.1 g Whole milk powder @ 28.5% milk fat, 36% sugars—lactose, 0% IDF, 4.9 kcal/g+17.3 g cocoa liquor @ 53.5% cocoa fat+0.3% sugars, 18.8% IDF, 5.3 kcal/g+5.3 g cocoa butter @ 100% fat, 8.84 kcal/g)+4.3 g fat (cocoa butter)+0.6 g polyglycerol polyricinoleate (PGPR) @ 100% fat, 9 kcal/g+20.5 g sugar @ 3.87 kcal/g, +39 g bulking agent. The formulation of the dark chocolate sample was as follows: 24.5 g fat (cocoa butter)+10 g cocoa liquor (@ 53.5% cocoa fat+0.3% sugars, 18.8% IDF, 5.3 kcal/g)+0.5 g PGPR+7 g sugar+58 g bulking agent.

The inventive sample Milk Choc Example FCC was prepared as follows.

Preparation of Refiner paste: 230 g cocoa liquor (product #NCL 2C602-082 from Barry Callebaut) was heated to 65° C. and poured into a running Vididem Jewel stainless steel rice grinder and the tension screw was set at ¼ turn below the maximum. After running for 5 hours (intermittent heating with a laboratory heat gun to keep the temperature of the mass above 50° C.), 174 g whole milk powder (product #136430, 28.5% fat from Dairy Farmers of America) and 70 g cocoa butter (Cacao Barry Deodorized Cocoa Butter, product #3073415310863) were added over 20 min and the tension was set at maximum. After 1 h, the mass was transferred onto a wax paper and stored for future use.

Preparation of milk chocolate: 11.6 g of refiner paste (above) and 4.3 g cocoa butter were melted in a KitchenAid Precise Heat Mixing Bowl attached to a KitchenAid Pro 600 Stand Mixer preheated to 52° C. Another 24 g of the refiner paste was cut to fine shards with a peeler. Next, 20.5 g sugar (Confectioners sugar from Dominos) that had been sieved through a 325 mesh (44 micron) was added and mixing was initiated using a flex-edge paddle at a speed of ‘4’. After 15 min, 39 g of MF:SF=2:1 composite (Table 2) was added over 5 min. Mixing was allowed to continue for 60 min (dry conching). After this, the bowl jacket temperature was raised to 68° C. and 24 g of the refiner paste shards were added over 1 h. After mixing for another 1 h, 0.6 g PGPR was added and mixing was continued for another 30 min, following which, with the bowl contents at 63° C. (using an infrared (IR) thermometer), heating was turned off. After mixing for an additional 20 min, the contents of the bowl reached a temperature of 47° C. At this point, 44 g of mass was removed from the bowl and spread into a thin layer (<5 mm) onto a wax paper, using a metal spatula (this was used as ‘seed’ for tempering). Both the layer on the wax paper and the contents of the bowl were stored overnight in ambient conditions.

After 18 h, the bowl jacket temperature was set to 65° C. and mixing speed was set at ‘2’. Once the contents of the bowl were at 62° C. (to ensure complete melting), the temperature setting of the bowl jacket was lowered to 38° C. and mixing speed was set at ‘5’. Meanwhile, the layer collected onto the wax paper had hardened overnight into a dark, shiny slab. This was chopped into fine shards (seed) using a peeler. Once the contents of the bowl achieved a temperature of 37° C., the bowl insert was removed from the jacket and the empty bowl jacket was set to a temperature of 38° C. The bowl insert was held by hand against the mixing paddle and mixing was allowed to continue at a setting of ‘4’.

With the contents of the bowl at 34° C., the fine shards (seed) were added. After adding 40 g of shards over 5 min while mixing (to ensure that the shards were broken down and did not form large lumps), the temperature of the mass had dropped to 30° C. and the mass had turned into a sticky, dough-like paste and lost its ‘sheen’. Next, the bowl was re-inserted into the jacket, which was at 38° C. and the mass was mixed at a setting of ‘5’. After 10 min, the mass had the appearance of molten chocolate, with a temperature reading of 39° C. At this point, the chocolate mass (75 g) was transferred into a silicone mold which was placed on a vibrating table to remove air bubbles. Simultaneously, 150±2 mg of the mass was placed in a sample glass cup for TMA testing. After overnight storage in ambient conditions, a milk chocolate bar with good snap was formed.

The inventive sample Dark Choc Example FCC was prepared as follows.

10 g cocoa liquor (product #NCL 2C602-082 from Barry Callebaut) and 14.5 g cocoa butter (Cacao Barry Deodorized Cocoa Butter, product #3073415310863) were melted in a KitchenAid Precise Heat Mixing Bowl attached to a KitchenAid Pro 600 Stand Mixer preheated to 52° C. Next, 7 g sugar (Confectioners sugar from Dominos) that had been sieved through a 325 mesh (44 micron) was added and mixing was initiated using a flex-edge paddle at a speed of ‘2’. After 5 min, 58 g of MF:SF=1:1 composite (Table 2) was added over 5 min. The mixing speed was increased to ‘4’ and mixing was allowed to continue for 30 min (dry conching). After this, another 10 g cocoa butter were added and the temperature setting of the bowl jacket was raised to 62° C. and mixing was continued. After mixing for 45 min, the temperature of the mass within the bowl was at 57° C. (using an IR thermometer) and it had a smooth, chocolate-like appearance.

At this point, 30 g of mass was removed from the bowl and spread into a thin layer (<5 mm) onto an Aluminum foil, using a metal spatula (this was used as ‘seed’ for tempering). The remaining mass within the bowl was allowed to continue mixing at 62° C. and mixing speed of ‘4’ (wet conching). After mixing for 135 min, the contents of the bowl were at 62° C. Next, the temperature setting of the bowl jacket was lowered to 50° C. Once the contents of the bowl achieved a temperature of 48° C., the heating on the bowl jacket was turned ‘off’ and 0.5 g PGPR were added and mixing speed was increased to ‘5’. At this point, the bowl contents had the appearance of a shiny, free flowing molten chocolate mass. Meanwhile, the 30 g layer collected onto the Aluminum foil had hardened into a slab. This was chopped into fine shards (seed) using the metal spatula. Once the contents of the bowl achieved a temperature of 35° C., the bowl insert was removed from the jacket and the empty bowl jacket was set to a temperature of 35° C.

The bowl insert was held by hand against the mixing paddle and mixing was allowed to continue at a setting of ‘4’, while slowly adding in the fine shards (seed). After adding 28.7 g of shards over 10 min while mixing (to ensure that the shards were broken down did not form large lumps), the temperature of the mass had dropped to 30° C. and the mass had turned into a sticky paste and lost its ‘sheen’. Next, the bowl was re-inserted into the jacket, which was set to 35° C. and the mass was mixed at a setting of ‘4’. After 15 min, the mass had once again the appearance of smooth, shiny, free-flowing molten chocolate, with a temperature reading of 34.5° C. At this point, the chocolate mass (72 g) was transferred into a silicone mold which was placed on a vibrating table to remove air bubbles. Simultaneously, 150±2 mg of the mass were placed in a sample glass cup for TMA testing. After overnight storage in ambient conditions, a dark chocolate bar with good snap was formed.

Notably, while the exemplary samples listed in Table 3 above are included herein to demonstrate the methodology of preparation and the results of crème-making and chocolate-making on a bench in a laboratory, it will be appreciated that various processing techniques, equipment, and unit operations may be implemented commercially to manufacture the fat continuous confections described above.

The TMA test procedure for the milk chocolate and dark chocolate inventive examples was identical to that used for the crèmes, except that the equilibration temperature was set at 15° C., since the melting point of cocoa butter is typically above 30° C. and it is expected to contain more than 50% solids at 15° C.

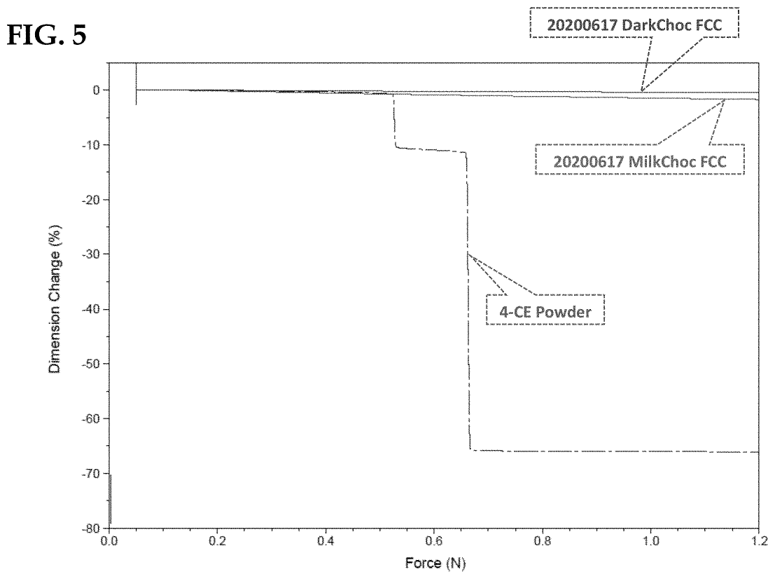

FIG. 5 illustrates a thermomechanical analyzer-generated plot of % dimension change vs. force for the comparative 4-CE Powder in Table 3 (broken double dash line, blue) and the two chocolate inventive samples in Table 3, namely, Milk Choc FCC (solid line, green) and Dark Choc FCC (solid line, purple). FIG. 5 illustrates the differences in rheological behavior of a powder (i.e., 4-CE Powder) and the fat continuous chocolate confections (i.e., Milk Choc FCC and Dark Choc FCC) when subjected to a force ramp as per the test procedure, at a temperature of 15° C.

As can be seen in FIG. 5, being a discontinuous powder, comparative sample 4-CE Powder initially resists deformation, but as the load increases, it shows significant (greater than 5%) deformation/dimension change. In addition, FIG. 5 shows that the dimension change happens discontinuously, suggesting that the probe slips between the particles, as is expected in the case of a mass of discontinuous powder particles coated with fat. On the other hand, inventive chocolate samples Milk Choc FCC and Dark Choc FCC show very little deformation/dimension change (i.e., under 5%) throughout the test. More importantly, even the minimal deformation that does occur in inventive samples Milk Choc FCC and Dark Choc FCC, which are fat continuous confections (chocolates in these examples), is continuous, suggesting that each sample behaves as a single, fat continuous mass, the rheological behavior of which is governed by the fat.

The fat continuous confectionery compositions described herein advantageously have reduced fat, sugar, and calorie content while having high insoluble dietary fiber content, and exhibiting pleasant organoleptic properties when consumed. One of the advantages of the compositions described herein is their ability to form a fat continuous confection even when including very high insoluble fiber levels of up to 86 wt. % and at fat content as low as about 14 wt. %. In addition, some embodiments of the fat continuous confectionery compositions described herein advantageously include composite particles made of insoluble fiber particles that are combined with and at least in part coated by soluble fiber.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A fat continuous confection comprising:
from about 24 wt. % to about 86 wt. % insoluble dietary fiber;
from about 14 wt. % fat to about 39 wt. % fat; and
from about 0 wt. % to about 20 wt. % sweetener.

2. The fat continuous confection of claim 1, wherein the fat continuous confection is selected from a group consisting of: chocolate, crème, crème filling of a baked product, a savory filling, a chocolate chip of a chocolate chip cookie, an icing of a doughnut, an icing of a cake, a chocolate filling enrobed by a chocolate layer, and a nut butter.

3. The fat continuous confection of claim 1, wherein the insoluble dietary fiber is from a source including at least one of: brans, celluloses, hemicelluloses, lignins, resistant starches, flours, insoluble chicory root fiber, isolated plant fibers, cocoa powder, pecan shell fiber, maple fiber, cocoa pod husk fiber, and agave pina fiber.

4. The fat continuous confection of claim 1, wherein the sweetener is selected from a group consisting of: sucrose, glucose, fructose, lactose, maltose, isomaltose, isomaltulose, trehalose, allulose, arabinose, xylose, sorbose, tagatose, allose, mannose, cellobiose, nigerose, kojibiose, inulobiose, stevia, monkfruit, sucralose, aspartame, Ace-K, neotame, and saccharin.

5. The fat continuous confection of claim 1, wherein the sweetener is not a sugar alcohol.

6. The fat continuous confection of claim 1, wherein the fat is selected from a group consisting of: canola oil, palm oil, high oleic canola oil, soybean, safflower, sunflower, palm kernel oil, shea butter, mango kernel oil, illipe oil, sal oil, olive oil, milk fat, cocoa butter or fractions or equivalents of cocoa butter, polyglycerol esters, glycerophospholipids, mono- and di-glycerides, sucrose monoesters, sorbitan esters, polyethoxylated glycols, agar, albumin, casein, glyceryl monostearate, gums, soaps, irish moss, egg yolk, lecithin, and mixtures thereof.

7. The fat continuous confection of claim 1, further comprising from about 0 wt. % to about 62 wt. % soluble dietary fiber.

8. The fat continuous confection of claim 7, wherein the soluble dietary fiber is from a source including at least one of: polydextrose, inulin, fructo-oligosaccharides, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, human milk oligosaccharides, 2′-fucosyl lactose, lacto-n-neotetraose, glucan (i.e., glucose containing) oligosaccharides, isomalto-oligosaccharides, cello-oligosaccharides (or cellodextrins), resistant dextrins (e.g., soluble corn fiber, soluble wheat fiber, soluble tapioca fiber), nigero-oligosaccharides, nigerotriose, nigerotetraose, kojitriose, kojitetraose, dextrans, beta glucans, lichenan, and isolichenan.

9. The fat continuous confection of claim 1, wherein the fat continuous confection comprises between 24 wt. % to 86 wt. % 1 total fiber content.

10. The fat continuous confection of claim 1, wherein a ratio of carbohydrate to fat in the fat continuous confection is from 1.7:1 to 6:1.

11. The fat continuous confection of claim 1, wherein the fat continuous confection is starch-free.

12. The fat continuous confection of claim 1, wherein the fat continuous confection has a water activity (A_{w}) not exceeding 0.7.

13. The fat continuous confection of claim 1, wherein the fat continuous confection has a caloric value of from about 1.5 kcal/g to about 4.2 kcal/g.

14. The fat continuous confection of claim 1, wherein the fat continuous confection comprises composite particles having a core made of insoluble dietary fiber particles, the core being at least in part coated by a shell made of soluble dietary fiber.

15. The fat continuous confection of claim 14, wherein the composite particles have a size distribution D90 of less than about 85 microns and a specific surface area of from about 0.05 m²/g to about 1 m²/g.

16. A fat continuous confection comprising:
from about 24 wt. % to about 56 wt. % insoluble dietary fiber;
from about 22 wt. % fat to about 39 wt. % fat; and
from about 22 wt. % to about 35 wt. % sweetener.

17. The fat continuous confection of claim 16, wherein the fat continuous confection is selected from a group consisting of: chocolate, crème, crème filling of a baked product, a chocolate chip of a chocolate chip cookie, a savory filling, an icing of a doughnut, an icing of a cake, a chocolate filling enrobed by a chocolate layer, and a nut butter.

18. The fat continuous confection of claim 16, wherein the sweetener is not a sugar alcohol.

19. The fat continuous confection of claim 16, wherein the fat continuous confection comprises composite particles having a core made of insoluble dietary fiber particles, the core being at least in part coated by a shell made of soluble dietary fiber.

20. The fat continuous confection of claim 19, wherein the composite particles have a size distribution D90 of less than about 85 microns and a specific surface area of from about 0.05 m²/g to about 1 m²/g.
